(19) United States
(12) Patent Application Publication
(10) Pub. No.: US 2022/0121789 A1
(43) Pub. Date: Apr. 21, 2022

(54) SIMULATION OF URBAN EVOLUTION TO TEST RESILIENCE OF CELLULAR NETWORKS

(71) Applicant: AT&T Intellectual Property I, L.P., Atlanta, GA (US)

(72) Inventors: Yaron Kanza, Fair Lawn, NJ (US); Teyu Hsiung, Short Hills, NJ (US); Arun Jotshi, Parsippany, NJ (US)

(73) Assignee: AT&T Intellectual Property I, L.P., Atlanta, GA (US)

(21) Appl. No.: 17/071,172

(22) Filed: Oct. 15, 2020

(51) Int. Cl. G06F 30/20; G06T 17/00; G06T 19/20

(52) U.S. Cl. CPC G06F 30/20; G06F 2111/16; G06T 19/20; G06T 17/00

(57) ABSTRACT

Aspects of the subject disclosure may include, for example, specifying changes to a three-dimensional model of the environment to simulate changes in the environment over time and identifying impacts on a communication system. Simulated changes may include increased building density, increased building heights, changes in vegetation, or the like. Other embodiments are disclosed.

### FIELD OF THE DISCLOSURE

The subject disclosure relates to network planning in cellular networks.

### BACKGROUND

Radio Access Networks (RAN) that utilize very short wavelengths (e.g., millimeter scale) typically operate line-of-sight (LOS), which means that any location desiring coverage should have a direct line of sight to at least one antenna in the network. This typically results in an increased number of antennas in the RAN installation, which translates into increased costs.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a diagram illustrating an example, non-limiting embodiment of a 3D model of an environment in which antennas of the communication network of FIG. 1 may be placed in accordance with various aspects described herein.

FIG. 2B is a diagram illustrating various antenna locations and coverage points in accordance with various aspects described herein.

FIG. 2C is a block diagram illustrating an example, non-limiting embodiment of data flow for simulation of urban evolution to test resilience of 5G cellular networks.

FIG. 2D is a block diagram illustrating an example, non-limiting embodiment of groupings of building in a 3D model useful to specify model changes.

FIG. 2E is a diagram illustrating an example, non-limiting embodiment of building locations in a 3D model prior to updating the 3D model.

FIG. 2F is a diagram illustrating an example, non-limiting embodiment of building locations in a 3D model after updating the 3D model.

FIG. 2G is a diagram illustrating an example, non-limiting embodiment of ray tracing emanating from an antenna.

FIG. 2H is a diagram illustrating an example, non-limiting embodiment of ray tracing emanating from a coverage point.

FIG. 2I depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for simulating changes in an environment and determining what effects, if any, the changes in the environment have on a communication system deployed in that environment. For example, an environment that includes buildings, vegetation, and other possible signal obstructions may be modeled as a number of shapes. The model may be modified to simulate changes in various building attributes (e.g., building shape, size, height, density). The model may also be modified to simulate changes in any other environmental objects included in the model (e.g., vegetation, road signs, park benches, awnings, etc.). The robustness of a RAN installation (proposed or installed) may then be measured against the modified model of the environment. Other embodiments are described in the subject disclosure.

One or more aspects of the subject disclosure include a processing system that includes a processor and a memory that stores executable instructions that, when executed by the processing system, facilitate performance of operations. The operations may include receiving a change specification to a three dimensional (3D) model of an environment that includes models of buildings and vegetation in the environment, wherein the change specification specifies a change in a number of buildings in the environment, a change in heights of buildings in the environment, or a combination thereof. The operations may also include simulating growth of the environment by modifying the 3D model of the environment in accordance with the change specification to produce a modified 3D model of the environment. The simulation may also include adding trees to the 3D model of the environment, or increasing the density of trees in specified areas. The operations may further include determining from the modified 3D model of the environment, effects of the growth of the environment on coverage of a communication network.

One or more aspects of the subject disclosure include a non-transitory machine-readable medium, comprising executable instructions that, when executed by a processing system including a processor, facilitate performance of operations. The operations may include obtaining a first three dimensional (3D) model of an environment and specifying changes to the first 3D model of the environment, wherein the changes to the first 3D model of the environment represent possible growth patterns of the environment over time. The operations may further include generating a modified 3D model of the environment in response to the specifying changes to simulate the possible growth patterns over time, and determining from the modified 3D model of the environment, effects of the possible growth patterns of the environment over time on coverage of a communication network.

One or more aspects of the subject disclosure include a method that includes placing elements in a three dimensional (3D) model of an environment, wherein the elements represent a plurality of antennas that are located within the environment to provide line of sight (LOS) communications to a plurality of coverage points in the 3D model of the environment. The method may further include simulating changes to the environment by modifying the 3D model of the environment to create a modified 3D model of the environment that includes changes to shapes in the 3D model that represent buildings in the environment, and identifying any of the plurality of coverage points in the modified 3D model of the environment for which LOS communications to the plurality of antennas is impacted.

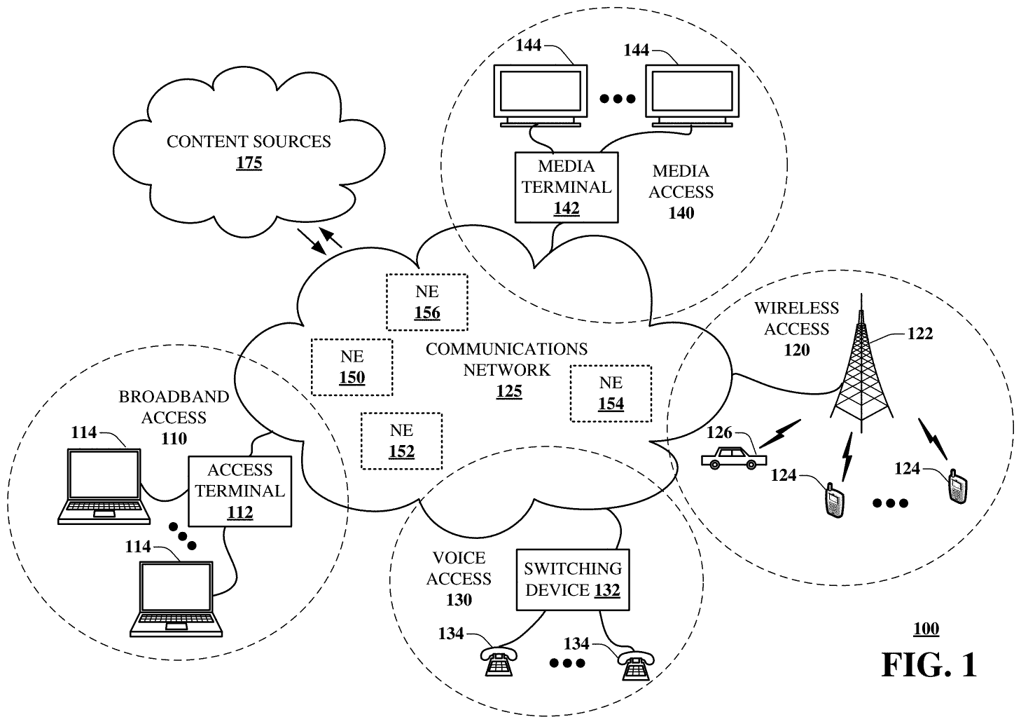

Referring now to FIG. 1, a block diagram is shown illustrating an example, non-limiting embodiment of a system 100 in accordance with various aspects described herein. For example, system 100 may include base stations and antennas placed for LOS coverage. As described further various aspects of the disclosure may test resilience of the antenna placements with respect to modeled changes in the environment. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

As further described below, the environment in which the base stations 122 and mobile devices 124 operate may include obstacles to LOS communication, such as buildings, vegetation, and other items. In various embodiments, the base stations are placed (or planned to be placed) in the environment to achieve LOS communications with desired coverage areas. Changes in the environment (e.g., changes in building heights, densities, or other attributes) may then be modeled to test the resilience of the base station placements to various changes in the environment.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

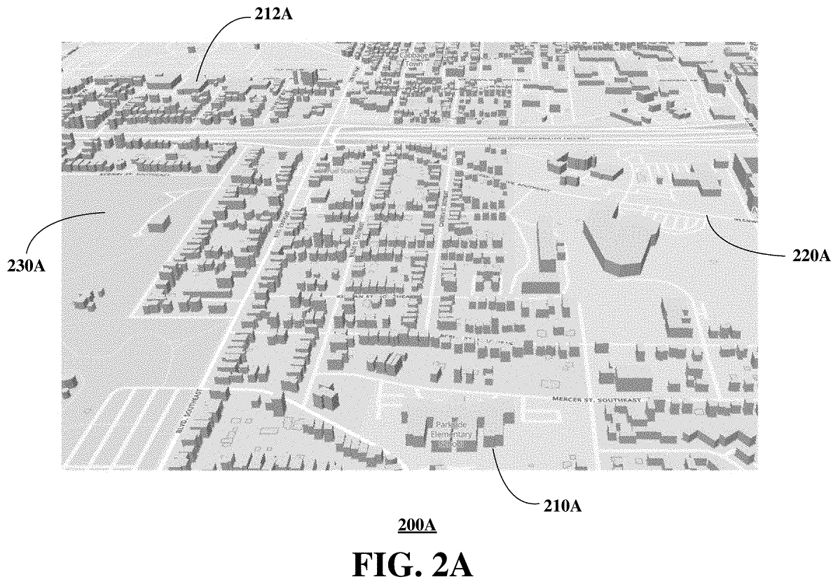

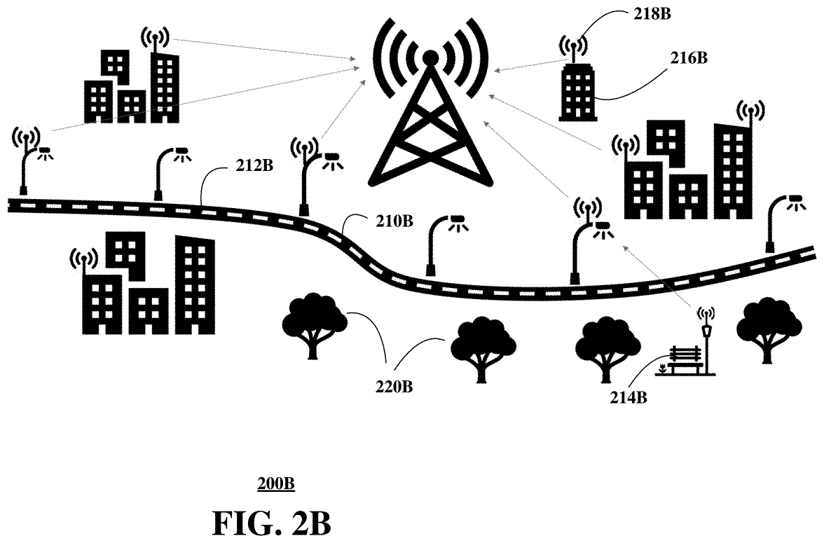

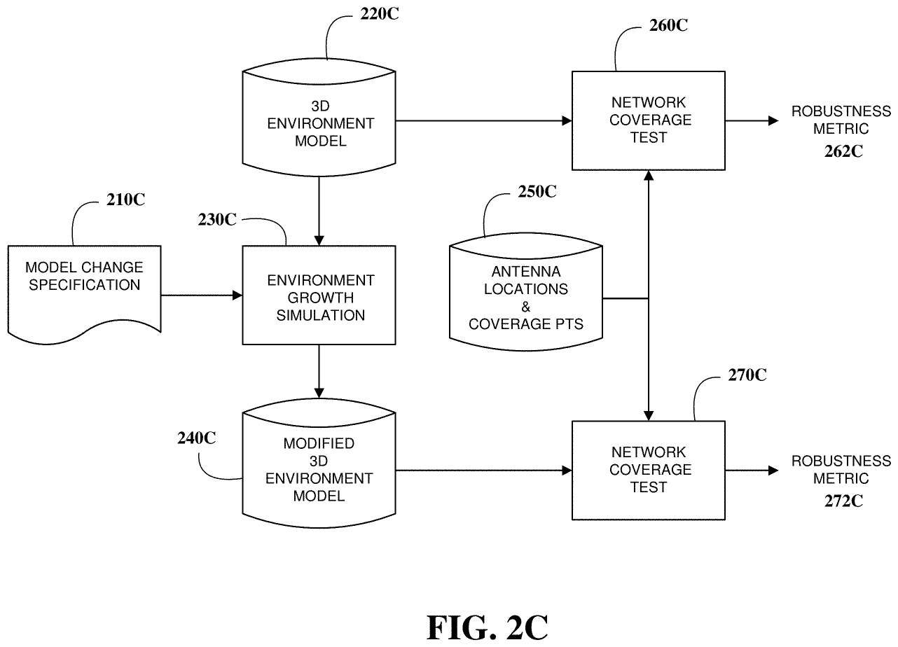

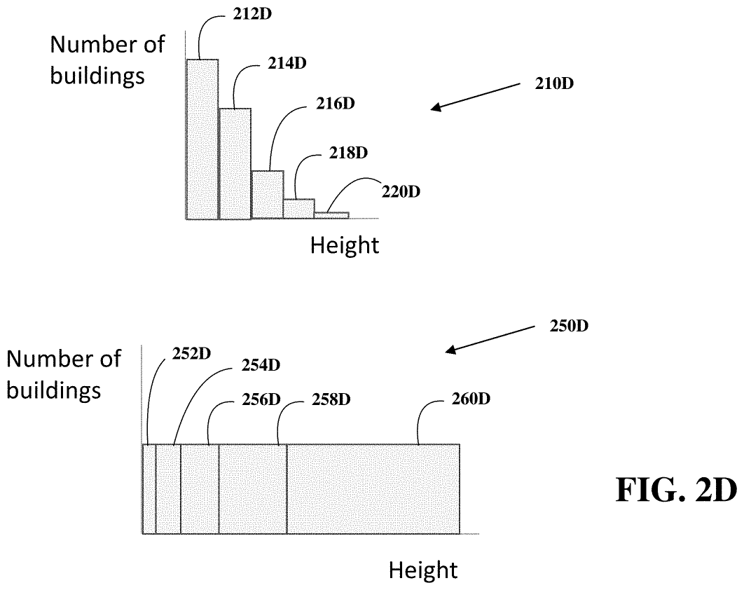

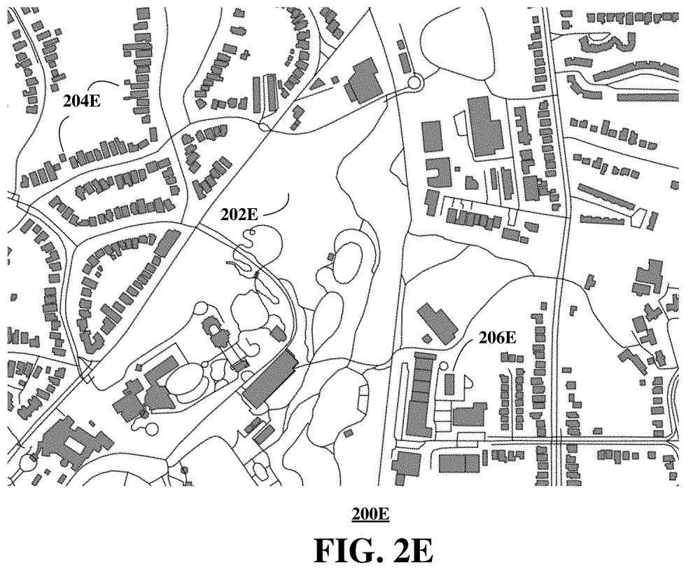

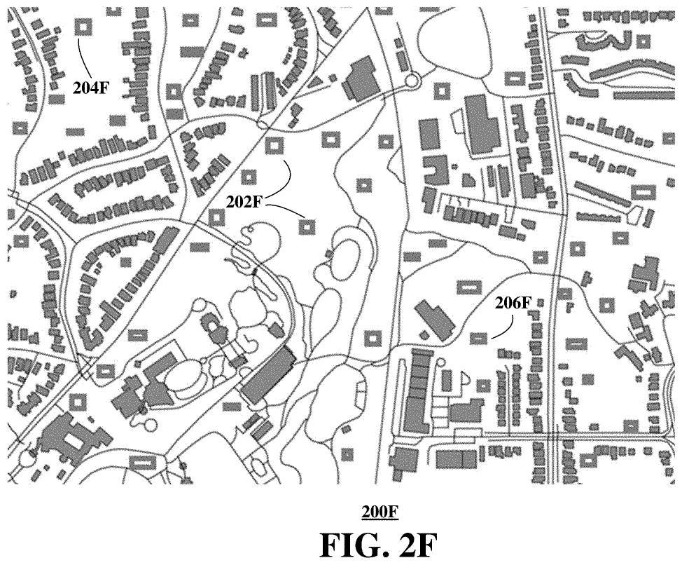

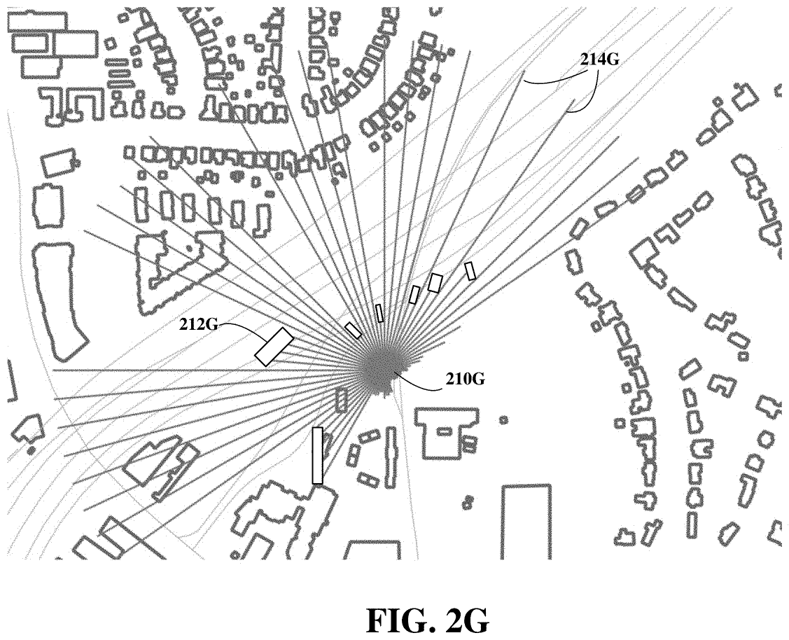

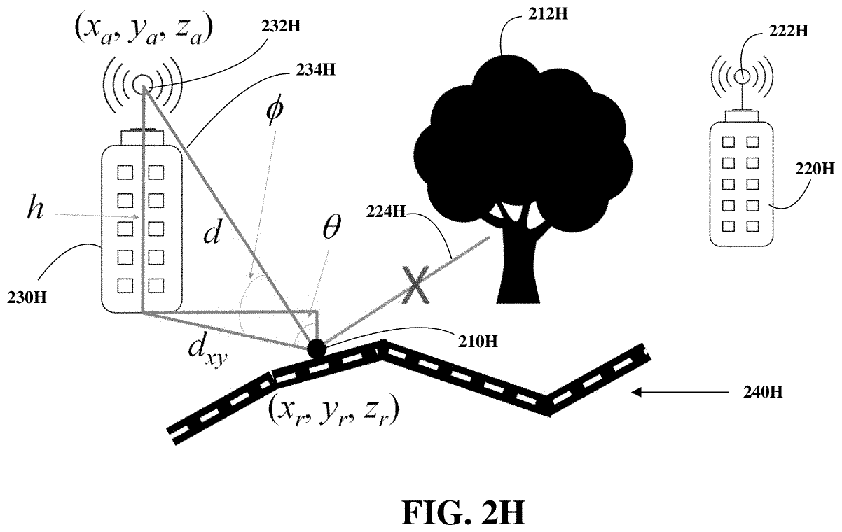

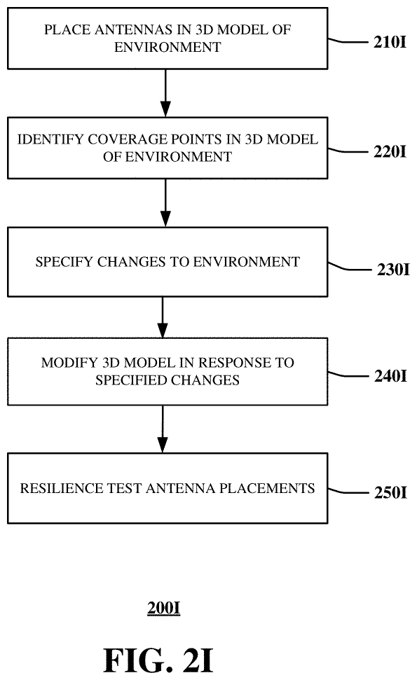

FIG. 2A is a diagram illustrating an example, non-limiting embodiment of a 3D model of an environment in which antennas of the communication network of FIG. 1 may be placed in accordance with various aspects described herein.

3D model 200A includes many shapes that represent buildings. For example, shape 210A represents a school, and shape 212A represents a building in an industrial park. Any number or type of buildings may be included in a 3D model of an environment. For example, the number of buildings represented in the 3D model is limited only by the size of the environment being modeled. Some embodiments model entire urban or suburban areas, whereas other embodiments model more limited areas such as dense downtown blocks or a particular industrial park.

Buildings may be represented in model 200A in any manner. For example, some embodiments model buildings as shapes that include a footprint represented as a polygon and a height value. Other embodiments may model buildings as complex 3D shapes. In some embodiments, 3D shapes may be representative of the actual physical shape and in other embodiments 3D shapes may be representative of the effective shape which can be different from the physical shape and which takes into account factors such as materials from which the building is made (where materials have different properties and therefore different effects) or changes occurring at different times such as the swaying of a building or movement of trees at different times of the year. In some embodiments, changes in shapes of trees may also reflect the effect of leaves during the summer and the lack of leaves during spring, fall, and/or winter. Also in some embodiments, 3D shapes in model 200A may represent potential shapes of movable structures such as drawbridges and movable highway barriers.

In some embodiments, 3D building data is sourced commercially, and in other embodiments, building footprints are sourced commercially, and height data is combined with the footprint data to create 3D building models. For example, height data may be determined from a Light Detection and Ranging (LiDAR) point cloud. The LiDAR point cloud may be commercially available or may be proprietary data that is measured by a private party.

3D model 200A also includes open areas such as park 230A. Models may include any designations for area types. For example, a 3D model may include designations for parks, wetlands, public lands, land designated for high density development, and the like. Area designations may be represented within 3D model 200A in any manner. For example, an area may be represented by a single polygon or by the union or intersection of multiple polygons.

3D model 200A may also include any other type of object. For example, in some embodiments, 3D model 200A also includes roadways, such as roadway 220A. In some embodiments, roadways are represented as polylines in the 3D model, and each polyline may include a number of discrete points, also referred to herein as road segments. Also for example, 3D model 200A may include shapes that represent vegetation such as trees and/or shrubs. The shapes may be specified as footprint polygons and height values, as complex 3D shapes, or in any other manner.

Coverage points may be defined at any 3D point within the environment, where a “coverage point” is any point at which cellular coverage is desired. For example, road segments may be identified as coverage points. Also for example, points within a park may be identified as coverage points. Similarly, points in parking lots or alleyways may be identified as coverage points. In general, any three-dimensional point in a 3D model of the environment may be identified as a coverage point.

Coverage points may be defined at any location and at any density. For example, in some embodiments, coverage points are defined every ten meters on roadways, and in other embodiments, coverage points are defined every meter on roadways. Also for example, coverage points may be defined in a regular grid pattern within parks at any resolution.

In addition to coverage points, antennas may be placed at any three-dimensional point in the 3D environment. For example, antennas may be placed on buildings, on lampposts, on street signs, on utility poles, or any other supporting structure. In some embodiments, antenna locations may be defined by elements within the 3D model. For example, antenna locations may be represented by records in a database along with records that represent buildings, trees, and other elements in 3D model 200A. In other embodiments, antenna locations may be defined in a dataset that is separate from the dataset that is used to represent 3D model 200A. For example, 3D model 200A may be defined by elements in a table or database, and the antenna locations may be defined by elements in a different table or database.

3D model 200A may be represented by data in any format. For example, 3D model 200A may be represented in a database. A flat database may include one record for each element, where an element represents a building, a tree, an antenna, a road segment, a coverage point, an antenna location, or any other item represented in the model. A relational database may include many tables, that when joined appropriately, provide representations of the various elements in the model. For example, a first table may include records for buildings, a second table may include records for attributes of buildings, a third table may include records for vegetation, a fourth table may include records for types of vegetation, and so on.

FIG. 2B is a diagram illustrating various antenna locations and coverage points in accordance with various aspects described herein. As shown in FIG. 2B, antennas may be placed in various locations, such as atop buildings, lampposts, and signposts. For example, antenna 218B is shown atop building 216B. FIG. 2B also shows examples of coverage points at 210B, 212B, and 214B. Coverage points 210B and 212B are located on road segments, and coverage point 214B is located at a park bench. Although only three coverage points are shown in FIG. 2B, any number of coverage point locations may be defined, at any 3D location, and at any density. In addition, FIG. 2B also shows trees 220B.

In some embodiments, all the items shown in FIG. 2B are included in a 3D model, such as 3D model 200A (FIG. 2A). For example, a 3D model may include elements that represent buildings, lampposts, park benches, trees, roadways, as well as antenna locations and coverage points. In other embodiments, the 3D model may not include all the items shown in FIG. 2B. For example, as described above, antenna locations and coverage points may be represented in a dataset outside of the 3D model. Further, in some embodiments, elements in the 3D model are limited to just buildings, or just buildings and trees. The richness of the 3D model is not meant to be limiting.

In some embodiments, very high frequency (small wavelength) operation of the communication network results in the deployment of many antennas, where each antenna represents a small cell. “Small cell” is a term used to refer to a small area covered by each antenna. Transmissions of small cells operating at very small (millimeter-scale) are blocked by buildings, trees and other obstacles. For example, a transmission may be blocked by a building that is in the line of sight (LOS) between a small cell and a coverage point.

Various embodiments determine the robustness of a communication network deployment by determining if each coverage point has an uninterrupted LOS to at least one antenna. Further, various embodiments also simulate growth (or changes generally) by updating the 3D model of the environment and then determine the robustness of the network deployment in the face of a changing environment. These and other embodiments are described further below.

FIG. 2C is a block diagram illustrating an example, non-limiting embodiment of data flow for simulation of urban evolution to test resilience of 5G cellular networks. Although various aspects are described with reference to 5G cellular networks, this is not meant to be limiting. For example, various embodiments described herein may test the resilience or robustness of any communication system that deploys antennas and desires to provide coverage to coverage points.

3D environment model 220C is a 3D model of an environment such as 3D model 200A (FIG. 2A). As described above, 3D environment model 220C may include any number or type of elements that represent objects in the environment such as buildings, vegetation, and the like.

Antenna locations and coverage points 250C are shown separate from 3D environment model 220C. In some embodiments, the antenna locations are included in the 3D model, and in other embodiments, the coverage points are included in the 3D model. In still further embodiments, both the antenna locations and the coverage points are included in the 3D model.

Antenna locations are the result of the planning phase of a radio access network (RAN) in a communication system. In some embodiments, the antenna locations may represent actual physical locations at which antennas have been previously placed. In other embodiments, the antenna locations may represent proposed physical locations at which antennas may be placed.

Coverage points are the result of specifying points in the physical world where network coverage is desired. In some embodiments, coverage points are automatically generated. For example, coverage points may be specified every meter on every roadway, or may be automatically specified in a grid pattern in parks. In other embodiments, coverage points may be manually specified. For example, a graphical user interface may allow a user to select points in a graphical representation of the 3D model, thereby specifying coverage points. Also for example, coverage points may be a combination of automatically generated coverage points and manually specified coverage points.

Network coverage test 260C receives 3D environment model 220C and antenna locations and coverage points 250C and determines whether each coverage point has line of sight to at least one antenna. As described in more detail below, in some embodiments, network coverage test 260C performs ray tracing from every antenna radially outward to determine if a ray reaches every coverage point without first being obstructed by an element in the 3D model, such as a building or tree. In other embodiments, ray tracing is performed from each coverage point to nearby antennas to determine if there is at least one unobstructed line of sight to at least one antenna.

Robustness metric 262C is generated by network coverage test 260C. In some embodiments, robustness metric 262C provides a measure of network coverage for the communication network as originally proposed or implemented. For example, in some embodiments, robustness metric 262C may be a simple count of the number of coverage points that do not have line of sight to at least one antenna. In other embodiments, robustness metric 262C may apply a weighting factor to individual coverage points based on how important network coverage is at that particular coverage point. For example, a road segment may have a higher weighting factor than a coverage point in a park. Any type of robustness metric may be utilized, and the particular method with which the metric is determined is not meant to be limiting.

Model change specification 210C specifies how to modify 3D environment model 220C to simulate changes in the environment over time. For example, model change specification 210C may specify height increases in buildings, increases in building density, and changes in size, type of amount of vegetation, including trees.

Model change specification 210C may specify changes in any manner. For example, a change specification might include an entry that causes a particular percentage of buildings within a particular height range to incur an increase in height. Continuing with this example, a specification entry might cause 10% of all two-story buildings to become three story buildings, or 5% of all buildings above five stories to become 20% taller. Also for example, increases in building density may be specified in any manner. For example, model change specification 210C may specify a change that causes a park to become developed, resulting in buildings being erected in an area that previously had none. Also for example, a specification entry may cause an increase in building density based on the type of area or zoning. For example, industrial areas may have an increase in building density of 10%, while residential areas do not experience any increase in building density.

In some embodiments, model change specification entries may be limited to specific geographical areas. For example, a polygon may be identified within which one or more specification change entries may apply. Continuing with this example, a polygon may be drawn around a dense urban area and a first set of model change specification entries may apply only to that area, and a second polygon may be drawn around an industrial area adjacent to the urban area and have a different set of model change specification entries applied.

By specifying different changes to the 3D model based on locations, types, and sizes of buildings or areas, any type of growth pattern may be specified. Further, by providing the ability to specify a percentage of model elements to undergo change without specifying the particular model elements to undergo the change, the simulation may be run multiple times with the same model change specification with varying results. This may be useful when simulating future growth in the environment when the results of that future growth are not fully known at the time of the simulation.

Model change specification 210C may be generated in any manner. For example, in some embodiments, model change specification 210C is a text file that includes commands to directly update a 3D environment model in a relational database. Also for example, in some embodiments a graphical user interface is provided that allows a user to draw polygons and enter specification entries in dialog boxes, which are then saved in model change specification 210C. In other embodiments, the generation of model change specification 210C may be automated. For example, a model change specification may be programmatically generated using data that reflects actual changes observed over time.

Environment growth simulation 230C creates modified 3D environment model 240C by modifying 3D environment model 220C according to entries in model change specification 210C. For example, environment growth simulation 230C may modify elements within 3D environment model 220C to increase the height or density of buildings, vegetation, or the like.

In some embodiments, environment growth simulation 230C modifies only those model elements that are specified directly in model change specification 210C. In other embodiments, environment growth simulation 230C selects elements partially at random based on model change specification entries. For example, if a model change specification entry specifies that 10% of a set of buildings is to be modified, environment growth simulation 230C may randomly or pseudorandomly select 10% of the buildings of the specified set to modify. Accordingly, through the model change specification entries and the programmatic control of environment growth simulation 230C, any modification may be specified, and any modification result may be achieved.

Modified 3D environment model 240C includes all changes specified in model change specification 210C. For example, modified 3D environment model 240C may include height increases to some buildings, new buildings, additional trees, changes in sizes and/or shapes of trees, and the like. In some embodiments, modified 3D environment model 240C represents changes to the environment represented in 3D environment model 220C that are predicted to occur over time. For example, a particular model change specification may be used to simulate growth over a five-year period, resulting in modified 3D environment model having a first set of changes. Also for example, a different model change specification may be used to simulate environment growth over a 10 year period, resulting in modified 3D environment model 240C having a second set of changes.

Network coverage test 270C determines a robustness metric 272C in the same manner that network coverage test 260C generated robustness metric 262C. Robustness metric 272C provides a measure of the resilience of the RAN planning represented by antenna locations 250C to the simulated passage of time, resulting environmental growth.

In some embodiments, the process represented in FIG. 2C may be run any number of times using the same or different model change specifications. For example, the same model change specifications can result in different modified models depending on how changes are specified. This results in different building heights and locations, which may or may not materially affect the robustness of the network. Also for example, the simulation may be run with different model change specifications to simulate changes on a larger scale or of a greater magnitude. An iterative approach to RAN planning may take place in which antenna locations are modified in response to a first set of simulations and resilience tests, and then the antenna locations may be modified in response to changes in the robustness metrics.

FIG. 2D is a block diagram illustrating an example, non-limiting embodiment of groupings of building in a 3D model useful to specify model changes. FIG. 2D shows buildings in a model (or part of a model) binned into separate bins. For example, a histogram is shown at 210D, where buildings are grouped into bins that have the same height range but are not the same size. For example, bin 212D may include buildings between zero and 10 meters, bin 214D may include buildings between 11 and 20 meters, bin 216D may include buildings between 21 and 30 meters, bin 218D may include buildings between 31 and 40 meters, and bin 220D may include buildings taller than 40 meters. The declining size of the bins from left to right reflects the fact that the model represented has more building in the first size range than in the other size ranges, and the number of buildings decreases as the height range increases. Also for example, buildings are shown binned into quantiles at 250D, where the number of buildings in each bin is the same, and the height ranges are computed accordingly.

Binning as shown in FIG. 2D may be used to specify model changes. For example, a model change specification entry may include two lines such as:

MODIFY Building.height BY [−10, −10, 0, 15, 5]

LIMIT TO ST_Polygon((75 29.3 1.77 29 1, 77.6 29.5 1)).

In this example, the MODIFY command specifies the change for each bin. The first and second bins have building heights decreased by 10%, third bin remains unchanged, the fourth bin has building heights increased by 15%, and the fifth bin has building heights increased by 5%. The second line limits the change to a specified polygonal area in the 3D model. Another example model change specification entry may include:

MODIFY RANGES FOR Building.height BY [−10, −10, 0, 15, 5]

LIMIT TO ST_Polygon((75 29.3 1.77 29 1, 77.6 29.5 1)).

In this example, the MODIFY command defines a change by modifying height range sizes per bin, where the change is limited to a specified polygonal area.

In some embodiments, these sample update entries may be used directly by the environment growth simulation 230C to modify the 3D model. For example, the simulation may parse these entries and programmatically update the elements in the model that represent the buildings to be modified. In other embodiments, these sample update entries may be translated into a series of SQL update commands that can be executed directly in a relational database management system to modify a 3D model represented in a series of data tables in a relational database.

Although the binning and model update examples discussed with reference to FIG. D use building heights as an example, various embodiments are not limited in this regard. For example, any other attribute of a 3D environment model may be binned and updated in a similar manner.

FIG. 2E is a diagram illustrating an example, non-limiting embodiment of building locations in a 3D model prior to updating the 3D model. Diagram 200E represents a portion of a 3D model prior to being modified by a simulation run. The 3D model includes a park 202E, a light industrial area 204E, and a retail area 206E.

FIG. 2F is a diagram illustrating an example, non-limiting embodiment of building locations in a 3D model after updating the 3D model. Diagram 200F shows an increase in building density. For example, the retail area includes a new building 206F, the park includes a number of new buildings 202F, and the light industrial area includes new buildings including building 204F.

The model updates may be specified by a model change specification such as model change specification 210C (FIG. 2C). The model may undergo many other changes in addition to increased building density. For example, building heights may be modified, trees may be added or modified, or any other element in the 3D model may be added, removed, or modified in any manner.

FIG. 2G is a diagram illustrating an example, non-limiting embodiment of ray tracing emanating from an antenna. In some embodiments, the ray tracing shown in FIG. 2G is performed by network coverage test 260C and/or network coverage test 270C (FIG. C). As shown in FIG. 2G, an antenna is located at 210G, and rays are traced radially outward to represent possible line of sight communications. Some rays, such as those shown at 214G are unobstructed and reach their maximum distance. Any coverage points in these areas will be found to have LOS communications with the antenna at 210G. Other rays terminate at obstructions. For example, an obstruction at 212G obstructs some rays and creates a shadow beyond which, LOS communications with antenna at 210G are not available. Any coverage points in these shadows will be found to not have LOS communications with the antenna at 210G. Obstructions such as the obstruction at 212G may be any element in a 3D model, including a building, a tree, or the like.

Raytracing emanating from antenna locations is an effective approach to determine if there are obstructions to line of sight communications; however, as the number of antennas grows, the computational intensity of this type of ray tracing increases quickly.

FIG. 2H is a diagram illustrating an example, non-limiting embodiment of ray tracing emanating from a coverage point. FIG. 2H shows antenna 232H atop building 230H, antenna 222H atop building 220H, tree 212H, roadway 240H. and coverage point 210H. Coverage point 210H is shown at a 3D position of (xᵣ, yᵣ, zᵣ), and antenna 232H is shown at a 3D position of (xₐ, yₐ, zₐ). In the ray tracing shown in FIG. 2H, at most one ray is computed for each pair of road segment and antenna. For example, a ray 224H is computed from coverage point towards antenna 222H and is found to be obstructed by tree 212H. A second ray 234H is computed from coverage point towards antenna 232H and a LOS is found.

In some embodiments, prior to computing a ray, all antennas are found within range. This may be done using an index, or by computing the distance between the coverage point of interest and all nearby antennas. The LOS from the coverage point to an antenna is determined by rotating the scene in the 3D model towards the antenna when a camera is located at the coverage point, and then if the antenna is visible from the camera, there is line of sight. Otherwise, there is no LOS.

To compute the rotation of the scene, the angle phi between the earth surface and the antenna, and the angle theta between north and the antenna's direction are computed. These angles may be computed based on the location of the antenna, the location of the coverage point, the distance d to the antenna and the height h of the antenna. These parameters are illustrated in FIG. 2H.

In some embodiments, network coverage tests are performed using only ray tracing emanating from antenna locations, and in other embodiments, network coverage tests are performed using only ray tracing emanating from coverage points. In still further embodiments, network coverage tests use a combination of the two.

FIG. 2I depicts an illustrative embodiment of a method in accordance with various aspects described herein. Method 200I begins at 210I, where antennas are placed at antenna locations in a 3D model of an environment. In some embodiments, this is a result of radio access network planning, and the locations of antennas are proposed locations for a future deployment. In other embodiments, the antenna placements represent actual physical locations of antennas in a prior deployment of a radio access network.

The locations of the antennas may be included as elements in the 3D model of the environment or may be specified separately. For example, referring now back to FIG. 2C, antenna locations may be included within a 3D environment model such as 3D environment model 220C, or may be maintained separately such as at 250C. In some embodiments, the antennas may be placed on top of buildings, light posts, road signs, or any other supporting structure. Further, in some embodiments, antenna locations are considered points in a 3D space, and are completely specified by a three tuple (x,y,z). In other embodiments, antenna placements are specified with additional attributes, such as size, orientation, power, and the like.

At 220I, coverage point locations are identified in the 3D model of the environment. In some embodiments, coverage points are located on road segments. Further, in some embodiments, coverage points are located in areas of the 3D environment other than road segments. Examples include sidewalks, alleyways, open spaces such as parks, and any other locations where communications coverage is desired. Coverage point locations may be identified in any manner. For example, coverage points may be automatically generated by specifying a coverage point every meter on every roadway in the 3D model, or by specifying a grid over a two-dimensional land area for which cover is desired. In some embodiments, the actions of 220I are performed when a user interacts with a graphical user interface presenting the 3D model of the environment. For example, a user may identify coverage points by selecting 3D points in the model of the environment.

In general, coverage points are considered points in a 3D space, and may be represented solely by a three tuple (x,y,z). The locations of the coverage points may be included as elements in the 3D model of the environment or may be specified separately. For example, referring now back to FIG. 2C, coverage points may be included within a 3D environment model such as 3D environment model 220C or may be maintained separately such as at 250C.

At 230I, changes to the environment are specified. In some embodiments changes to the environment are specified by creating or modifying a model change specification, such as model change specification 210C (FIG. 2C). Specifying changes to the environment may include specifications to change a 3D model of the environment that includes models of buildings in the environment and the change may specify a change in the number of buildings, a change in the heights of the buildings, or a combination thereof.

In some embodiments a change specification may specify a first change in building density in the first area of the environment and a second change in building density in a second area of the environment. The chain specification may also specify a first percentage of buildings of a first height range in the 3D model of the environment to undergo a first height modification and a second percentage of buildings of a second height range in the 3D model of the environment to undergo a second height modification.

In some embodiments, the changes specified to the 3D model may represent possible growth patterns over time. For example, building heights may increase as a result of building remodels or additions, and building density may increase over time as a result of further development. In addition, vegetation may change over time as trees grow and additional vegetation is added to the environment.

In some embodiments, specifying changes to the 3D model of the environment includes grouping shapes in the 3D model that represent elements such as buildings in the environment into a plurality of bins according to building heights represented by the shapes and specifying changes to the building heights separately for each bin of the plurality of bins. In some embodiments, the bins may be histograms and 3D model elements are binned separately based on attributes of the elements such as building height. In other embodiments, bins may be quantiles in which the number of elements in each bin is constant.

Changes to the environment may be specified in any manner. For example, a text file may be created that includes commands to modify a relational database that represents the 3D model of the environment. In these embodiments, the commands may be translated into database update commands, such as SQL update commands. Also for example, the change specification may be modeled graphically, and a computer program that can interpret the graphical representation may be employed to determine the specified changes.

At 240I, the 3D model of the environment is modified in response to the specified changes. The actions at 240I may be performed by an environment growth simulation such as environment growth simulation 230C in FIG. 2C. The result of the actions at 240I is a modified 3D environment model such as environment model 240C in FIG. 2C.

Simulating growth of the environment by modifying the 3D model of the environment in accordance with the change specification may represent hypothetical growth of an area of the environment overtime. For example, building heights, sizes, or shapes may change over time, vegetation may change over time, and any other element in a 3D model of the environment may be modified to represent changes over time. As a result of the actions at 240I, the modified 3D environment model represents a hypothetical model of the environment in the future.

In some embodiments, individual elements in the 3D model are modified. For example, a building may be represented by a polygonal footprint and a height value. The simulation may modify the polygonal footprint of the building and or the height of the building. In some embodiments, multiple buildings are modified by the simulation. As described above, the buildings to be modified by the simulation may be specified as a percentage of buildings of a particular type, a particular height, or having a particular attribute. Other elements within the 3D model that may be modified include vegetation, open spaces that may be developed in the future, and the like.

At 250I, the antenna placements are tested for resilience against the hypothetical future growth pattern. In some embodiments, the actions of 250I may be performed by a network coverage test such as network coverage test 260C or network coverage test 270C shown FIG. 2C. Resilience testing may identify any of the coverage points in the modified 3D model of the environment for which line of sight communications to an antenna is impacted. For example, a particular coverage point may have had line of sight to at least one antenna in the original 3D model prior to modification, and then an additional building or a change in height of an existing building may obstruct that line of sight, impacting the coverage of the communication network.

The resilience testing may be performed by computing rays from each antenna location and determining if every coverage point is covered by a ray from an antenna. In other embodiments, the resilience test may be performed by computing rays starting at each coverage point and determining if there is a line of sight to at least one antenna.

In some embodiments, method 200I is performed repeatedly and iteratively. For example, if the resilience test at 250I determines that impacts to the coverage of the communication network are unacceptable, the placement of antennas at 210I may be modified and then the process may be repeated. Also for example, method 200I may be repeated by specifying different changes to the environment at 230I to represent hypothetical growth patterns over different periods of time, or to model more aggressive changes or less aggressive changes to the environment. In yet another example, actual changes in the 3D environment may be measured, the 3D model may be updated, and method 200I may be repeated. By performing method 200I multiple times with changes in antenna placements, coverage point locations, and change specifications, a radio access network with increased robustness may be achieved.

While for purposes of simplicity of explanation, the respective processes are shown and described as a series of blocks in FIG. 2I, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

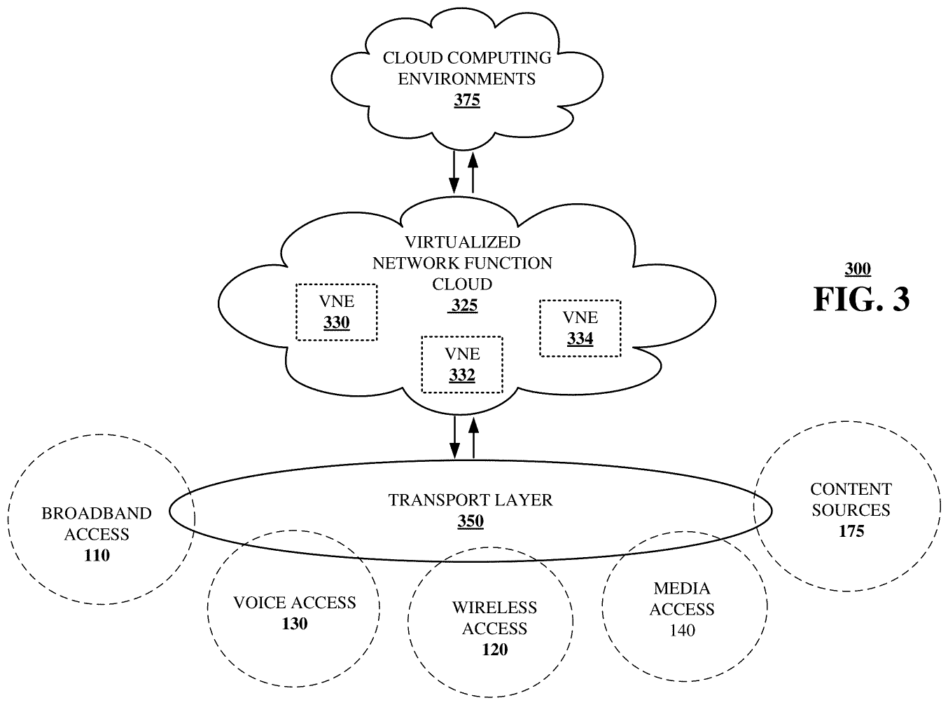

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, including a radio access network. The placement of antennas in virtualized communication network 300 may be resilience tested using the simulated environmental growth over time discussed above with reference to previous figures.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

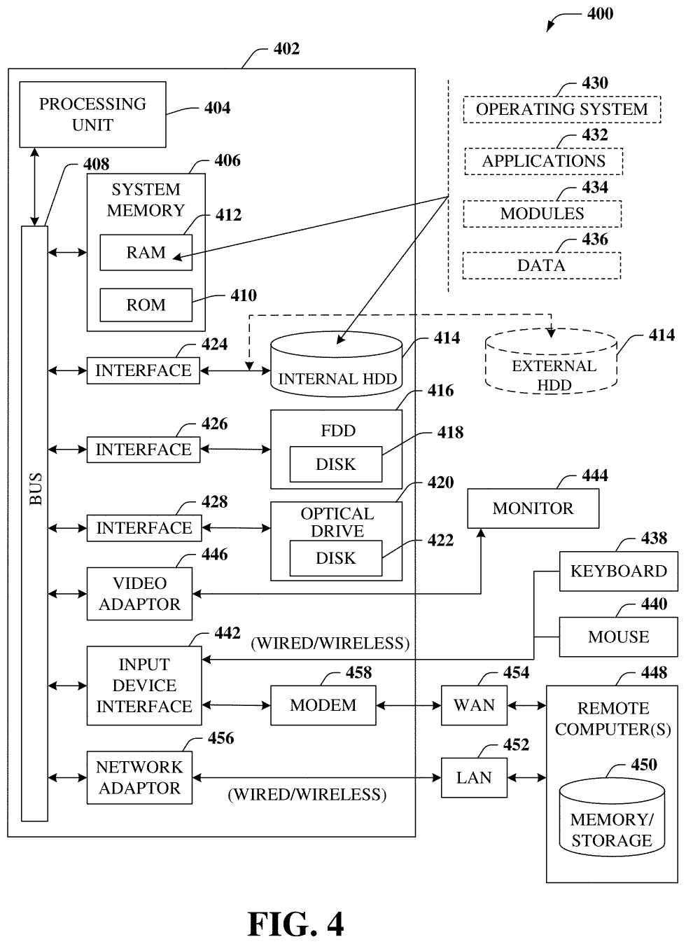

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part radio access network planning including the placement of antennas in a 3D model of the environment. Also for example, computing environment 400 can facilitate in whole or in part the production of change specifications, updates of 3D models to model hypothetical future growth, and resilience testing of communications networks against hypothetical future growth.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

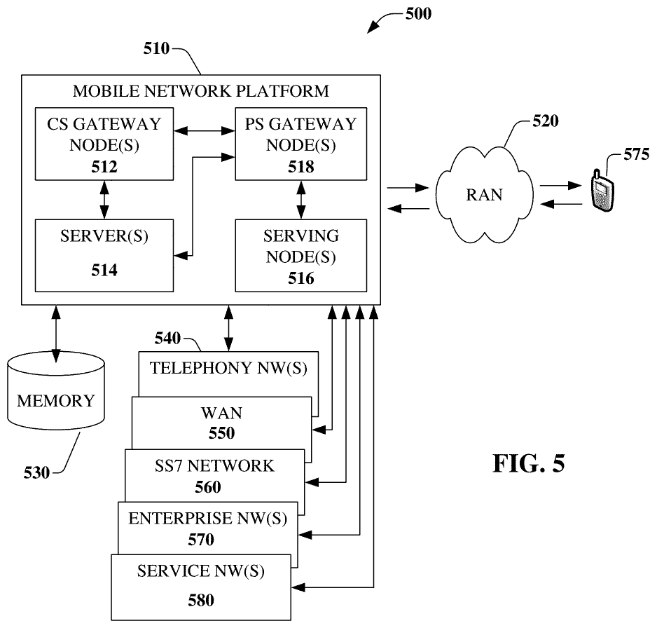

Turning now to FIG. 5, an embodiment 500 of a mobile network platform 510 is shown that is an example of network elements 150, 152, 154, 156, and/or VNEs 330, 332, 334, etc. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

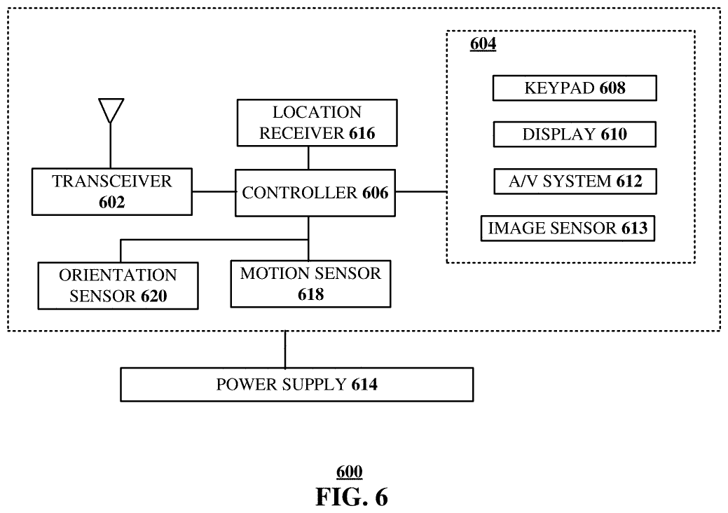

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving a change specification to a three dimensional (3D) model of an environment that includes models of buildings in the environment, wherein the change specification specifies a change in a number of buildings in the environment, a change in heights of buildings in the environment, or a combination thereof;
simulating growth of the environment by modifying the 3D model of the environment in accordance with the change specification to produce a modified 3D model of the environment; and
determining from the modified 3D model of the environment, effects of the growth of the environment on coverage of a communication network.

2. The device of claim 1 wherein the change specification specifies a first change in building density in a first area of the environment, and a second change in building density in a second area of the environment.

3. The device of claim 1 wherein the change specification specifies a first percentage of buildings of a first height range in the 3D model of the environment to undergo a first height modification, and a second percentage of buildings of a second height range in the 3D model of the environment to undergo a second height modification.

4. The device of claim 1 wherein:
the modified 3D model of the environment includes elements representing a plurality of antennas in the communication network, includes shapes that represent buildings in the environment, and includes points that represent a plurality of coverage points in the communication network; and
the determining comprises identifying any of the plurality of coverage points in the modified 3D model of the environment for which line of sight (LOS) communications to the plurality of antennas is impacted.

5. The device of claim 4 wherein the plurality of coverage points includes points on road segments.

6. The device of claim 5 wherein the plurality of coverage points further include points not on road segments.

7. A non-transitory machine-readable medium, comprising executable instructions that, when executed by a processing system including a processor, facilitate performance of operations, the operations comprising:
obtaining a first three-dimensional (3D) model of an environment;
specifying changes to the first 3D model of the environment, wherein the changes to the first 3D model of the environment represent possible growth patterns of the environment over time;
generating a modified 3D model of the environment in response to the specifying changes to simulate the possible growth patterns over time; and
determining from the modified 3D model of the environment, effects of the possible growth patterns of the environment over time on coverage of a communication network.

8. The non-transitory machine-readable medium of claim 7 wherein the first 3D model of the environment includes a plurality of shapes that represent buildings in the environment.

9. The non-transitory machine-readable medium of claim 8 wherein the plurality of shapes are defined by building footprints and building heights.

10. The non-transitory machine-readable medium of claim 9 wherein the generating the modified 3D model of the environment comprises modifying the plurality of shapes to represent increased building heights in the environment.

11. The non-transitory machine-readable medium of claim 8 wherein the generating the modified 3D model of the environment comprises increasing a total number of shapes in the plurality of shapes to represent increased building density in the environment.

12. The non-transitory machine-readable medium of claim 7 wherein the specifying changes to the first 3D model of the environment comprises grouping shapes in the 3D model that represent buildings in the environment into a plurality of bins according to building heights represented by the shapes, and specifying changes to the building heights separately for each bin of the plurality of bins.

13. The non-transitory machine-readable medium of claim 12 wherein the plurality of bins includes an equal number of shapes.

14. The non-transitory machine-readable medium of claim 7 wherein:
the first 3D model of the environment includes a plurality of shapes that represent vegetation in the environment; and
the specifying changes comprising specifying at least one attribute the vegetation.

15. A method, comprising:
placing, by a processing system including a processor, elements in a three dimensional (3D) model of an environment, wherein the elements represent a plurality of antennas that are located within the environment to provide line of sight (LOS) communications to a plurality of coverage points in the 3D model of the environment;
simulating, by the processing system, changes to the environment by modifying the 3D model of the environment to create a modified 3D model of the environment that includes changes to shapes in the 3D model that represent buildings in the environment; and
identifying, by the processing system, any of the plurality of coverage points in the modified 3D model of the environment for which LOS communications to the plurality of antennas is impacted.

16. The method of claim 15 wherein the identifying comprises determining if a ray can be traced between each of the plurality of coverage points and at least one of the plurality of antennas without being obstructed by any of the shapes in the modified 3D model of the environment.

17. The method of claim 16 wherein the determining comprises determining if rays emanating from the plurality of antennas reach each of the plurality of coverage points without being obstructed by any of the shapes in the modified 3D model of the environment.

18. The method of claim 16 wherein the determining comprises, for each of the plurality of coverage points, if at least one ray can be traced to at least one of the plurality of antennas without being obstructed by any of the shapes in the modified 3D model of the environment.

19. The method of claim 15 wherein the plurality of coverage points includes points on road segments.

20. The method of claim 15 wherein the plurality of coverage points further include points not on road segments.
